(19) United States
(12) Patent Application Publication
(10) Pub. No.: US 2004/0117932 A1
(43) Pub. Date: Jun. 24, 2004

(54) Seal cleaning tool

(76) Inventors: Robert D. Breeding, El Dorado Hills, CA (US); Jeff L. Hodsdon, Folsom, CA (US)

Correspondence Address: ROBERT D. BREEDING, 1172 TURQUOISE WAY, EL DORADO HILLS, CA, 95762, US

(21) Appl. No.: 10/187,233

(22) Filed: Jul. 2, 2002

(51) Int. Cl. A47L 25/00; B08B 1/00

(52) U.S. Cl. 15/104.001; 15/236.01

(57) ABSTRACT

This invention is a tool that is primarily used to remove or extract foreign debris from a seal and its contact surface. This tool is thin and flexible and is made up of various types of materials. This tool has a special shape and texture to help assist in the removal the said debris. This is a completely new idea and no other prior art exists.

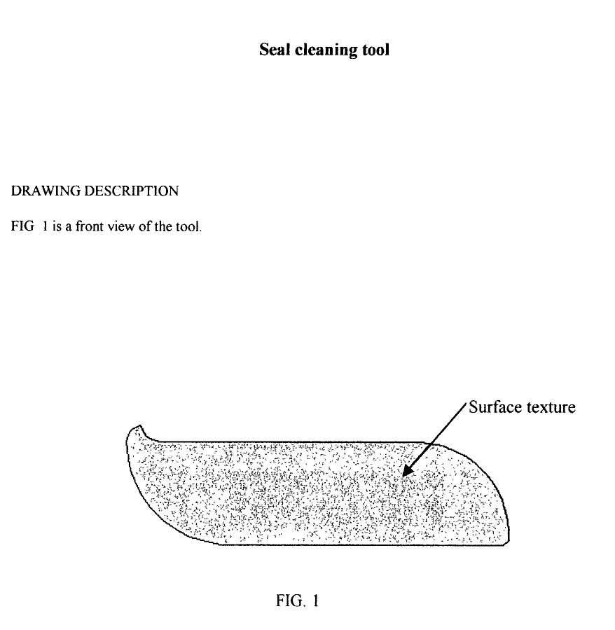

This invention relates to the removal of foreign debris between a leaking seal and its contact surface.

### BACKGROUND OF INVENTION

Some seals work in a contaminated environment. Foreign debris accumulates on and around the working portions of this seal. Occasionally this foreign debris is lodged between the seal and its contact surface, thus causing it to leak. This tool can quickly and effectively remove said debris from the seal and its contact surface restoring it to its original working condition.

### SUMMERY OF INVENTION

This tool will slide between the seal and its contact surface. This tool will remove foreign debris from the leaking seal and its contact surface. This tool works by extracting foreign debris trapped between the seal its contact surface by a sliding motion of the tool completely around the sealing portion of the seal. A principle object of this invention is to provide an economical and time saving way of restoring a faulty seal by not having to remove the seal.

One basic way in which this tool is cost effective is that it is not necessary to remove and or replace the existing seal. The removal of the seal can be a costly and lengthy process.

This tool quickly repairs a leaking seal back to working order, thus minimizing costly down time.

### DETAIL DESCRIPTION OF INVENTION

This invention is a tool that is primarily used to extract foreign debris lodged between a given seal and its contact surface. This debris causes the seal to leak by not giving the seal complete contact with its sealing surface.

This tool is film like, thin and flexible and is made from material selected from the group consisting of metals, plastics, alloys, carbon fibers, fiberglass, laminates, nylons, paper and or any other such type materials. This material includes a special matte like texture on its surface assisting in removal of foreign debris. This tool has a special hook like shape that will enable the ease of entry into a seal and its contact surface as well as assisting in the extraction of foreign debris while it is being rotated along the seal and its contact surface. The design of this hook like shape and make up of material will not damage the seal.

What I claim as my invention is:

1. A seal is a device preventing the passage of air and or fluid from one area to another.

2. Said seal and its contact surface may leak if foreign debris is entered on the sealing surface.

3. A tool inserted into said sealing contact surface can remove foreign debris and repair leaking said seal.

4. Said tool has a specific design that enables it to be inserted easily without damage to the said seal.

5. Said tool has a texture on its surface that assists it in the removal of foreign debris.

6. Said tool has a special hook like shape that assist in extracting foreign debris from the said seal and its contact surface.

7. Said tool can be made from material selected from the group consisting of metal, plastic, alloy, carbon fiber, fiberglass, laminate, nylon, fabric, paper and or any other such type materials.

8. Said tool is thin and film like.

9. Said tool is flexible.

10. Said tool will not damage said seal.
